(19) United States
(12) Patent Application Publication
(10) Pub. No.: US 2014/0154586 A1
(43) Pub. Date: Jun. 5, 2014

(54) LAMINATE FOR ALL-SOLID TYPE BATTERY

(71) Applicant: MURATA MANUFACTURING CO., LTD., Nagaokakyo-Shi (JP)

(72) Inventors: Takeshi Hayashi, Nagaokakyo-Shi (JP); Masutaka Ouchi, Nagaokakyo-Shi (JP); Makoto Yoshioka, Nagaokakyo-Shi (JP); Takeo Ishikura, Nagaokakyo-Shi (JP); Akisuke Ito, Nagaokakyo-Shi (JP)

(73) Assignee: MURATA MANUFACTURING CO., LTD., Nagaokakyo-Shi (JP)

(21) Appl. No.: 14/093,087

(22) Filed: Nov. 29, 2013

(30) Foreign Application Priority Data
Nov. 30, 2012 (JP) 2012-263812

(51) Int. Cl. H01M 10/052; H01M 4/48; H01M 10/0562

(52) U.S. Cl. CPC H01M 10/052; H01M 10/0562; H01M 4/48
USPC 429/322

(57) ABSTRACT

A laminate for an all-solid type battery which is an electrode/electrolyte laminate used in an all-solid type battery. The laminate includes a positive electrode layer, a solid electrolyte layer and a negative electrode layer in this order, and at least one intermediate layer disposed between (a) the positive electrode layer and the solid electrolyte layer and (b) the negative electrode layer and the solid electrolyte layer. The solid electrolyte layer contains a Li-containing oxide having a garnet crystal structure, and the intermediate layer contains monoclinic Li₂MO₃, where M represents Ti or Mn.

### BACKGROUND OF THE INVENTION

1. Field of the Invention

The present invention relates to a laminate for an all-solid type battery. Further, the present invention relates to an all-solid type battery using the laminate.

2. Description of the Related Art

Lithium ion batteries representing the secondary batteries are widely used for various purposes such as notebook-type personal computers, portable phones, digital cameras, and automobiles because of having a smaller weight, a smaller scale, and a larger capacity. In a conventional lithium ion battery, a solution (organic electrolytic solution) is used in which a lithium salt is dissolved as an electrolyte in a carbonate-based organic solvent. However, it is reported that, because such an electrolytic solution is combustible, there are problems such as rupture and ignition caused by leakage of the electrolytic solution, decomposition of the electrolytic solution or the like. For this reason, an all-solid type battery is recently proposed in which a solid electrolyte is used in place of the electrolytic solution in order to enhance the safety to a further extent. An all-solid type battery is a battery in which the positive electrode, the negative electrode, and the electrolyte are all made solid (made totally solid), and various kinds of all-solid type batteries are being developed instead of conventional type batteries using an electrolytic solution. A representative example thereof is an all-solid type lithium ion secondary battery.

For example, there is known an all-solid type lithium ion secondary battery having a structure such that a solid electrolyte layer is interposed between a positive electrode containing a positive electrode active substance capable of storing and releasing lithium ions and a negative electrode containing a negative electrode active substance capable of releasing and storing lithium ions wherein the solid electrolyte layer is a layer of garnet-type oxide represented by a compositional formula of Li_{5+X}La₃(Zr_{X}, A_{2-X})O₁₂ (in the formula, A represents at least one kind of an element selected from the group consisting of Sc, Ti, V, Y, Nb, Hf, Ta, Al, Si, Ga and Ge, and X satisfies 1.4≦X<2) (See, for example, Japanese Patent Application Laid-open No. 2010-272344).

Also, there is known, for example, an all-solid type lithium secondary battery including a positive electrode, a negative electrode and a solid electrolyte containing ceramics made of Li, La, Zr and O and having a crystal structure of a garnet type or a crystal structure similar to that of a garnet type (See, for example, Japanese Patent Application Laid-open No. 2010-45019).

In the meantime, among these all-solid type batteries, there are batteries of a type in which, in forming the electrode layers and the solid electrolyte layer, each layer is formed by a general thin film forming method and batteries of a type (fired type) in which a sintered body is formed by firing a laminate of green sheets. In particular, in the case of the latter, that is, in the case of the laminate of the fired type, an arbitrary capacity design can be made, and also the production costs can be reduced to be low. Moreover, there is an advantage in that the laminate (sintered body) obtained by firing is an integrated body in which the layers are firmly bonded with each other.

### SUMMARY OF THE INVENTION

As described above, a garnet-type oxide used as a solid electrolyte layer is suitable for an all-solid type battery; however, when green sheets for electrodes are laminated on a green sheet for a solid electrolyte and fired, a solid-phase reaction may occur to cause decrease in the capacity of the battery. On this point, in order to obtain higher battery characteristics, a further improvement must be made in a fired-type laminate that uses a garnet-type oxide as the solid electrolyte layer.

Thus, a principal object of the present invention is to provide an electrode/electrolyte laminate for an all-solid type battery capable of realizing a higher battery capacity.

The present inventors have repetitively made eager researches in view of the aforementioned problems of the prior art and have found out that the aforementioned object can be achieved by adopting a specific layer construction, thereby completing the present invention.

In other words, the present invention relates to the following laminates for an all-solid type battery.

1. A laminate for an all-solid type battery which is an electrode/electrolyte laminate used in an all-solid type battery, wherein the laminate includes a positive electrode layer, a solid electrolyte layer and a negative electrode layer in this order, and at least one intermediate layer disposed between (a) the positive electrode layer and the solid electrolyte layer and (b) the negative electrode layer and the solid electrolyte layer. The solid electrolyte layer preferably contains a Li-containing oxide having a garnet crystal structure, and the intermediate layer preferably contains monoclinic Li₂MO₃, where M represents Ti or Mn.

Preferably, the laminate is a sintered body, the intermediate layer has a thickness of 1 μm to 50 μm, and the Li-containing oxide is a Li—La—O oxide.

In one embodiment, positive electrode layer and the negative electrode layer contain an electrode active substance of at least one kind selected from a lithium titanium oxide and a titanium oxide, each capable of storing and releasing Li ions, and the intermediate layer contains monoclinic Li₂TiO₃. Preferably, the electrode active substance is at least one kind selected from TiO₂, Li₄Ti₅O₁₂ and Li₂Ti₃O₇.

In another embodiment, the positive electrode layer and the negative electrode layer contain an electrode active substance of at least one kind selected from a lithium manganese oxide and a manganese oxide, each capable of storing and releasing Li ions, and the intermediate layer contains monoclinic Li₂MnO₃. Preferably, the electrode active substance is at least one kind selected from LiMn₂O₄, MnO₂, LiNi_{0.5}Mn_{1.5}O₄ and Li₂MnO₃—LiRO₂ solid solution, where R represents Ni or Co.

According to the present invention, there can be provided an electrode/electrolyte laminate for an all-solid type battery and further an all-solid type battery (in particular, an all-solid type secondary battery) that can realize a higher battery capacity. In the present invention in particular, the laminate is made of a sintered body in which a predetermined intermediate layer is interposed between the electrode layer and the solid electrolyte layer that uses a Li-containing oxide having a garnet crystal structure, so that the laminate can be integrally formed by firing while suppressing or preventing the reaction that causes decrease in the electric discharge capacity, at the time of firing. Therefore, battery characteristics equivalent to or more than those of an organic electrolytic solution secondary battery can be obtained while solving the problems (problems such as safety) of the conventional organic electrolytic solution secondary batteries.

Such all-solid type batteries can be widely used, for example, for various purposes such as notebook-type personal computers, portable phones, digital cameras, automobiles and other electronic instruments.

### BRIEF DESCRIPTION OF THE DRAWINGS

FIG. 1 is a view showing electric discharge characteristics of an all-solid type battery fabricated in the Examples;

FIG. 2 is a view showing electric discharge characteristics of an all-solid type battery fabricated in the Examples;

FIG. 3 is a view showing electric discharge characteristics of an all-solid type battery fabricated in the Examples;

FIG. 4 is a view showing electric discharge characteristics of an organic electrolytic solution secondary battery fabricated in the Comparative Examples;

FIG. 5 is a view showing electric discharge characteristics of an organic electrolytic solution secondary battery fabricated in the Comparative Examples;

FIG. 6 is a view showing electric discharge characteristics of an organic electrolytic solution secondary battery fabricated in the Comparative Examples;

FIG. 7 is a model view illustrating one exemplary layer construction of an electrode/electrolyte laminate of the present invention.

### DETAILED DESCRIPTION OF THE INVENTION

1. Electrode/Electrolyte Laminate and Method of Producing the Same

1-1. Electrode/Electrolyte Laminate

The electrode/electrolyte laminate of the present invention (hereafter referred to as “the present invention laminate”) is an electrode/electrolyte laminate used in an all-solid type battery, wherein the laminate includes a positive electrode layer, a solid electrolyte layer and a negative electrode layer in this order, and at least one intermediate layer disposed between (a) the positive electrode layer and the solid electrolyte layer and (b) the negative electrode layer and the solid electrolyte layer; the solid electrolyte layer contains a Li-containing oxide having a garnet crystal structure; and the intermediate layer contains monoclinic Li₂MO₃, where M represents Ti or Mn.

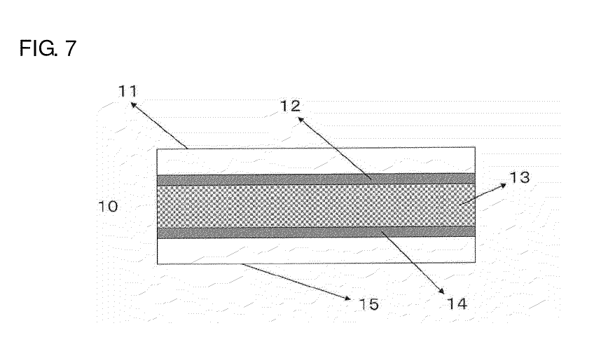

FIG. 7 is an exemplary model view illustrating a layer construction of the present invention laminate. This laminate 10 has a structure such that positive electrode layer 11, positive electrode side intermediate layer 12, solid electrolyte layer 13, negative electrode side intermediate layer 14 and negative electrode layer 15 are sequentially laminated in this order from the uppermost layer. Positive electrode side intermediate layer 12 is disposed to be adjacent to positive electrode layer 11 and solid electrolyte layer 13. Negative electrode side intermediate layer 14 is disposed to be adjacent to negative electrode layer 15 and solid electrolyte layer 13. The present invention laminate is a sintered body, and the layers are firmly bonded with each other as a polycrystal body. Hereafter each layer will be described.

Solid Electrolyte Layer

The component constituting the solid electrolyte layer is a Li-containing oxide having a garnet crystal structure (garnet-type Li-containing oxide). This garnet-type Li-containing oxide is not particularly limited; however, in particular, a Li—La—O oxide (further a Li—La—Zr—O oxide) can be suitably used.

As the Li—La—O oxide, in particular, Li₇La₃Zr₂O₁₂, Li₅La₃Nb₂O₁₂, Li₅La₃Ta₂O₁₂, Li₆BaLa₂Ta₂O₁₂, Li-containing oxides represented by a compositional formula of LiₓLn₃(M¹_{y}M²_{z})O₁₂ (here, Ln represents at least one kind of an element selected from the group consisting of La, Pr, Nd, Sm, Lu, Y, K, Mg, Ba, Ca and Sr; M¹ represents at least one kind of an element selected from the group consisting of Zr, Nb, Hf and Ta; M², which is an element different from M¹, represents at least one kind of an element selected from the group consisting of Si, Sc, Ti, Ga, Ge, Y, Zr, Nb, In, Sb, Hf, Ta, W and Bi; x represents a number satisfying 3≦x≦8; and y and z represent numbers satisfying y>0, Z≧0 and y+z=2), and others can be raised as specific preferable examples.

The solid electrolyte layer in the present invention may contain other components within a range that does not hinder the effects of the present invention; however, the ratio by which the Li-containing oxide occupies the solid electrolyte layer is typically set to be about 95 wt % to 100 wt %, preferably equal to 100 wt %. On the other hand, in the present invention, it is preferable that the solid electrolyte layer does not contain a sulfur-containing Li compound, a nitrogen-containing Li compound or a phosphorus-containing Li compound.

The thickness of the solid electrolyte layer is not particularly limited; however, the thickness is typically about 1 μm to 200 μm, preferably 5 μm to 50 μm. By setting the thickness of the solid electrolyte layer to be within the above range, further more excellent battery characteristics can be obtained.

Positive Electrode Layer and Negative Electrode Layer

As the electrode active substance contained in the positive electrode layer and the negative electrode layer (hereafter, both will be together referred to also as “electrode layer”), for example, an electrode active substance adopted in a known lithium ion secondary battery can be used; however, in particular, at least one kind of oxide selected from a titanium-based oxide and a manganese-based oxide can be suitably used. As the titanium-based oxide, at least one kind selected from TiO₂, Li₄Ti₅O₁₂ and Li₂Ti₃O₇ can be preferably used, for example. Also, as the manganese-based oxide, at least one kind selected from LiMn₂O₄, MnO₂, LiNi_{0.5}Mn_{1.5}O₄ and Li₂MnO₃—LiRO₂ solid solution, where R represents Ni or Co, can be preferably used, for example.

In the present invention, these oxides are present as a sintered body, so that these oxides are made of a crystal body (in particular, a polycrystal body) in the present invention laminate. Therefore, in the case of TiO₂, a rutile-type titanium oxide, an anatase-type titanium oxide and others can be raised as examples. In the case of Li₄Ti₅O₁₂, a spinel-type lithium titanium oxide and others can be raised as examples. In the case of Li₂Ti₃O₇, a ramsdellite-type lithium titanium oxide and others can be raised as examples. In the case of LiMn₂O₄, a spinel-type lithium manganese oxide and others can be raised as examples. In the case of MnO₂, a spinel-type manganese oxide, a ramsdellite-type manganese oxide and others can be raised as examples. In the case of LiNi_{0.5}Mn_{1.5}O₄, a spinel-type lithium manganese oxide and others can be raised as examples. In the case of Li₂MnO₃—LiRO₂ solid solution, where R represents Ni or Co, a type lithium manganese oxide and others can be raised as examples.

Also, in the present invention, the ratio by which the electrode active substance occupies the electrode layer is preferably set to be 85 wt % to 99 wt %, and components other than the electrode active substance may be contained in the electrode layer in accordance with the needs. For example, an electroconductive auxiliary agent can be used. The electroconductive auxiliary agent is not particularly limited, so that, for example, carbon materials such as carbon black and activated carbon, metal materials such as Ag, Pd, Cu, Ni and Al, and others can be used. The content of the electroconductive auxiliary agent, when used, in the electrode layer is not particularly limited. Typically, however, the content can be suitably set within a range of 1 wt % to 15 wt %.

The thickness of the electrode layer is not particularly limited; however, the thickness is typically set to be about 5 μm to 100 μm, particularly 10 μm to 50 μm. By setting the thickness of the electrode layer to be within the above range, further more excellent battery characteristics can be obtained. The thickness of the positive electrode layer and the thickness of the negative electrode layer may be the same or different from each other as long as the thicknesses are within the above range.

Intermediate Layer

The intermediate layer contains monoclinic Li₂MO₃, where M represents Ti or Mn. In other words, the present invention laminate has an intermediate layer containing at least one kind of oxide selected from monoclinic Li₂TiO₃ and monoclinic Li₂MnO₃. Each of these oxides suppresses unnecessary solid-phase reaction between the solid electrolyte layer made of a Li-containing oxide having a garnet crystal structure and the electrode layer, and also functions as a solid electrolyte in itself, thereby giving an advantage of not inhibiting the performance of the battery.

Components other than the oxide described above may be contained in the intermediate layer; however, the ratio by which the monoclinic Li₂MO₃ (where M represents Ti or Mn) occupies the intermediate layer is typically set to be 90 wt % to 100 wt %, preferably 95 wt % to 100 wt %.

With respect to the intermediate layer, not only the case of having both a positive electrode side intermediate layer and a negative electrode side intermediate layer as shown in FIG. 7, but also the case of having either one of a positive electrode side intermediate layer and a negative electrode side intermediate layer are comprised within the scope of the present invention. In the present invention, in the case of having both a positive electrode side intermediate layer and a negative electrode side intermediate layer, the materials (compositions and the like) of the two intermediate layers may be the same or different from each other.

The thickness of the intermediate layer is not particularly limited; however, the thickness is typically set to be about 1 μm to 50 μm, particularly 5 μm to 20 μm. By setting the thickness of the intermediate layer to be within the above range, further more excellent battery characteristics can be obtained.

In the present invention, it is preferable that the material of the intermediate layer is determined in accordance with a combination with the electrode layer that is to be adopted. When the electrode layer contains an electrode active substance of at least one kind selected from (1) a lithium titanium oxide and (2) a titanium oxide (excluding the lithium titanium oxide) capable of storing and releasing Li ions, then the intermediate layer preferably contains monoclinic Li₂TiO₃. In particular, it is more preferable that the intermediate layer is substantially made of monoclinic Li₂TiO₃. When the electrode layer contains an electrode active substance of at least one kind selected from (1) a lithium manganese oxide and (2) a manganese oxide (excluding the lithium manganese oxide) capable of storing and releasing Li ions, then the intermediate layer preferably contains monoclinic Li₂MnO₃. In particular, it is more preferable that the intermediate layer is substantially made of monoclinic Li₂MnO₃.

1-2. Method of Producing Electrode/Electrolyte Laminate

The method of producing the present invention laminate can be suitably carried out by a method having (1) a step of fabricating a laminate green sheet including a positive electrode layer forming layer, a solid electrolyte layer forming layer and a negative electrode layer forming layer in this order, and including an intermediate layer forming layer (a) between the positive electrode layer forming layer and the solid electrolyte layer forming layer and/or (b) between the negative electrode layer forming layer and the solid electrolyte layer forming layer (first step) and (2) a step of obtaining a sintered body by firing the fabricated laminate green sheet (second step).

First Step

In the first step, a laminate green sheet is fabricated that includes a positive electrode layer forming layer, a solid electrolyte layer forming layer and a negative electrode layer forming layer in this order, and includes an intermediate layer forming layer (a) between the positive electrode layer forming layer and the solid electrolyte layer forming layer and/or (b) between the negative electrode layer forming layer and the solid electrolyte layer forming layer.

The method of fabricating the laminate green sheet is not particularly limited; however, in particular, it is preferable to adopt a method of using a slurry (substance in a paste form) containing a starting material capable of forming each layer. In other words, it is possible to adopt, for example, (i) a method of fabricating a laminate green sheet by superposing green sheets (monolayer green sheets) prepared in advance by using a slurry, (ii) a method of fabricating a laminate green sheet by applying and drying a slurry on a surface of a monolayer green sheet so as to laminate a different layer thereon, (iii) a method of fabricating a laminate green sheet by combining the above (i) and (ii), or the like method.

Here, in the present invention, in forming one kind of a layer, one precursor layer may be formed, for example, with one layer of a monolayer green sheet or one layer (monolayer) of a coating layer having the same composition, or alternatively, as shown also in the later-described Examples, one precursor layer may be formed, for example, by laminating a plurality of monolayer green sheets or coating layers having the same composition.

The method of preparing the above slurry is not particularly limited, so that the slurry can be suitably prepared, for example, by mixing (wet-type mixing) and dispersing a starting material into an organic vehicle (organic binder) obtained by dissolving a polymer material into a solvent.

As the starting material, it is possible to use the material itself constituting each layer shown in the above 1-1. or a precursor thereof. The precursor may be, for example, an amorphous body of each oxide, a compound (hydroxide, chloride or the like) that can become a crystalline oxide (polycrystal body) by firing, or the like. When the material itself constituting each layer shown in the above 1-1. is used as the starting material, a crystal powder of the oxide constituting each layer can be suitably used. Also, the powder of the precursor can be suitably used as well. The average particle size of these powders is not particularly limited; however, the average particle size is typically within a range of about 0.5 μm to 20 μm, preferably 0.5 μm to 10 μm, in view of the sinterability, dispersibility and the like.

The polymer material is not particularly limited, so that, for example, acrylic resin, urethane resin, polyester resin, polyethylene resin, polypropylene resin, polyvinyl acetate, polyvinyl alcohol, polyvinyl butyral, polybutadiene, chloroprene rubber and others can be suitably used.

Also, the solvent may be, for example, ethanol, isopropyl alcohol, toluene, acetone, methyl ethyl ketone, normal hexane or the like. These can be suitably selected in accordance with the kind of the polymer material that is to be used and the like.

Here, the slurry may contain other components (plasticizer, dispersant, coloring agent, thickening agent or the like) in accordance with the needs. For these other components, known ones or commercially available ones can be used. For example, the plasticizer may be a phthalic acid ester such as dioctyl phthalate or diisononyl phthalate.

In preparing the slurry, the method of wet-type mixing is not particularly limited, so that either a method using a medium or a method not using a medium can be adopted. As the method using a medium, for example, the ball-mill method, the Visco-mill method or the like can be adopted. On the other hand, as the method not using a medium, for example, the sand mill method, the high-pressure homogenizer method, the kneader dispersion method or the like can be adopted. Here, the solid component content in the slurry in the case of preparing the slurry is not particularly limited; however, typically, the content may be suitably set within a range of 10 wt % to 60 wt %.

The method of preparing each precursor layer (the method of fabricating the above monolayer green sheet or the coating method) is not particularly limited, so that, for example, a known method using a die coater, a comma coater, screen printing or the like can be used. Also, the method of laminating the green sheets is not particularly limited, so that, for example, hot isostatic pressing, cold isostatic pressing, hydrostatic pressing or the like can be suitably used.

Second Step

In the second step, a sintered body is obtained by firing the above laminate green sheet. This allows that a laminate in which each layer is crystallized (polycrystallized) can be obtained.

The firing temperature may be a temperature at which the sintered body is produced, and can be suitably set, for example, in accordance with the composition of the green sheets or the like; however, the firing temperature is typically set to be 800° C. to 1200° C., preferably 900° C. to 1000° C. Also, the firing atmosphere may be generally an oxidizing atmosphere or an ambient air atmosphere; however, the firing atmosphere may be an inert gas (nitrogen gas, helium gas or the like) atmosphere.

Further, in the present invention, for the purpose of removing organic vehicles or the like, calcination may be carried out before the firing. The calcination temperature is not particularly limited and may be typically about 400° C. to 800° C. Also, the calcination atmosphere may be typically an oxidizing atmosphere or an ambient air atmosphere.

2. All-Solid Type Battery

An all-solid type battery using the present invention laminate as an electrode/electrolyte laminate is also comprised within the scope of the present invention.

The construction of the all-solid type battery can be suitably selected from among the constructions of known all-solid type batteries in accordance with the kind of the battery and the like. Therefore, in accordance with the needs, a predetermined battery can be assembled by suitably attaching a collector, a terminal, a housing container and the like that are adopted in known all-solid type batteries (for example, all-solid type lithium ion secondary batteries).

Also, the mode of the battery is not particularly limited, so that, for example, any mode such as a coin type, a pin type, a paper type, a cylindrical type or a prismatic type may be adopted.

### EXAMPLES

Hereafter, Examples and Comparative Examples will be shown to describe the characteristic feature of the present invention more specifically. However, the scope of the present invention is not limited to the Examples alone.

### Examples 1 to 5 and Comparative Examples 1 to 6

(1) Construction of the Battery to be Fabricated

Batteries having a construction shown in Table 1 were fabricated. In all of the all-solid type batteries (all-solid batteries), Li₇La₃Zr₂O₁₂ having a garnet crystal structure was used as the solid electrolyte layer. Also, carbon powder was used as the electroconductive auxiliary agent contained in the electrode layer.

TABLE 1

| | | Intermediate | Electrode layer |
|---|---|---|---|
| | Battery type | layer | (active substance) |
| Example 1 | All-solid type battery 1 | Li₂TiO₃ | TiO₂ |
| Example 2 | All-solid type battery 2 | Li₂MnO₃ | TiO₂ |
| Example 3 | All-solid type battery 3 | Li₂TiO₃ | Li₄Ti₅O₁₂ |
| Example 4 | All-solid type battery 4 | Li₂MnO₃ | LiMn₂O₄ |
| Example 5 | All-solid type battery 5 | Li₂TiO₃ | LiMn₂O₄ |
| Comparative | All-solid type battery 6 | — | TiO₂ |
| Example 1 | | | |
| Comparative | All-solid type battery 7 | — | Li₄Ti₅O₁₂ |
| Example 2 | | | |
| Comparative | All-solid type battery 8 | — | LiMn₂O₄ |
| Example 3 | | | |
| Comparative | Organic electrolytic | — | TiO₂ |
| Example 4 | solution battery 1 | | |
| Comparative | Organic electrolytic | — | Li₄Ti₅O₁₂ |
| Example 5 | solution battery 2 | | |
| Comparative | Organic electrolytic | — | LiMn₂O₄ |
| Example 6 | solution battery 3 | | |

(2) Preparation of a Slurry for Forming Each Layer (Laminate Green Sheet)

(i) A slurry for forming the electrode layer was prepared. First, a crystal powder (main material) of the electrode active substance shown in Table 2 was mixed into a PVA solution obtained by dissolving polyvinyl alcohol (PVA) into toluene, to prepare electrode active substance slurries 1 to 3. The blending ratio was set to be crystal powder:polyvinyl alcohol=70:30 (weight ratio). On the other hand, as an electroconductive auxiliary agent slurry, carbon powder was mixed into a PVA solution similar to that of the above (i) to prepare electroconductive auxiliary agent slurry 1. The blending ratio was set to be carbon powder:polyvinyl alcohol=70:30 (weight ratio). Subsequently, the above electrode active substance slurries 1 to 3 and electroconductive auxiliary agent slurry 1 were mixed so that the blending ratio of the electrode active substance:electroconductive auxiliary agent would be 90:10 in weight ratio, to prepare electrode layer forming slurries 1 to 3.

(ii) As a slurry for forming a solid electrolyte layer, a crystal powder of garnet-type lithium lanthanum zirconia compound (Li₇La₃Zr₂O₁₂) was mixed into a PVA solution similar to that of the above (i) to prepare solid electrolyte layer forming slurry 1. The blending ratio of the crystal powder:polyvinyl alcohol would be 70:30 in weight ratio.

(iii) As a slurry for forming an intermediate layer, a crystal powder (main material) of the material shown in Table 2 was mixed into a PVA solution similar to that of the above (i) to prepare intermediate layer forming slurries 1 to 2. The blending ratio of the crystal powder:polyvinyl alcohol would be 70:30 in weight ratio. As the main material, a monoclinic crystal powder was used for each.

(3) Fabrication of Monolayer Green Sheet

Electrode layer forming slurries 1 to 3, solid electrolyte layer forming slurry 1 and intermediate layer forming slurries 1 to 2 prepared in the above (2) were molded by the doctor blade method to attain a thickness of 10 μm (dry thickness), and thereby to fabricate electrode layer forming green sheets 1 to 3, solid electrolyte layer forming green sheet 1 and intermediate layer forming green sheets 1 to 2. The main material used in each of the monolayer green sheet is shown in Table 2.

TABLE 2

| | Main material |
|---|---|
| Electrode layer forming green sheet 1 | TiO₂ |
| Electrode layer forming green sheet 2 | Li₄Ti₅O₁₂ |
| Electrode layer forming green sheet 3 | LiMn₂O₄ |
| Solid electrolyte layer forming green sheet 1 | Li₇La₃Zr₂O₁₂ |
| Intermediate layer forming green sheet 1 | Li₂TiO₃ |
| Intermediate layer forming green sheet 2 | Li₂MnO₃ |

(4) Fabrication of Sintered-Type All-Solid Type Battery

About 50 sheets of solid electrolyte layer forming green sheets 1 stamped out to have a diameter of 12 mm were laminated to attain a thickness of about 500 μm and to form a solid electrolyte layer forming layer. Intermediate layer forming green sheets 1 to 2 and electrode layer forming green sheets 1 to 3 stamped out to have a diameter of 12 mm were thermally press-bonded to one surface of the solid electrolyte layer forming layer at a temperature of 80° C. with one ton to attain a construction shown in Table 3, and thereby to obtain laminate green sheets 1 to 8 corresponding to all-solid type batteries 1 to 8 that would constitute Examples 1 to 5 and Comparative Examples 1 to 3.

Subsequently, laminate green sheets 1 to 8 were interposed between two sheets of ceramic plates made of alumina and fired at 500° C. for two hours in an oxygen atmosphere (firing step 1) and, after polyvinyl alcohol was removed, the resultant was further fired at 1000° C. for two hours in a nitrogen atmosphere (firing step 2), to obtain sintered bodies (laminates) 1 to 8 of the all-solid type batteries.

After the obtained sintered bodies 1 to 8 were dried at 100° C. to remove the moisture component, a polymethyl methacrylate (PMMA) gel electrolyte was applied onto metal lithium used as a counterelectrode, and the fired laminate and the metal lithium were laminated so that the electrolyte sheet would be in contact with the application surface, followed by sealing with a 2032-type coil cell to fabricate all-solid type batteries 1 to 8.

TABLE 3

| | Electrode layer | Intermediate layer | Solid electrolyte layer |
|---|---|---|---|
| All-solid type | Electrode layer | Intermediate layer | Solid electrolyte |
| battery 1 | forming green sheet | forming green sheet | layer forming green |
| | 1 × 5 sheets | 1 × 1 sheet | sheet 1 × 50 sheets |
| All-solid type | Electrode layer | Intermediate layer | Solid electrolyte |
| battery 2 | forming green sheet | forming green sheet | layer forming green |
| | 1 × 5 sheets | 2 × 1 sheet | sheet 1 × 50 sheets |
| All-solid type | Electrode layer | Intermediate layer | Solid electrolyte |
| battery 3 | forming green sheet | forming green sheet | layer forming green |
| | 2 × 5 sheets | 1 × 1 sheet | sheet 1 × 50 sheets |
| All-solid type | Electrode layer | Intermediate layer | Solid electrolyte |
| battery 4 | forming green sheet | forming green sheet | layer forming green |
| | 3 × 5 sheets | 2 × 1 sheet | sheet 1 × 50 sheets |
| All-solid type | Electrode layer | Intermediate layer | Solid electrolyte |
| battery 5 | forming green sheet | forming green sheet | layer forming green |
| | 3 × 5 sheets | 1 × 1 sheet | sheet 1 × 50 sheets |
| All-solid type | Electrode layer | — | Solid electrolyte |
| battery 6 | forming green sheet | | layer forming green |
| | 1 × 5 sheets | | sheet 1 × 50 sheets |
| All-solid type | Electrode layer | — | Solid electrolyte |
| battery 7 | forming green sheet | | layer forming green |
| | 2 × 5 sheets | | sheet 1 × 50 sheets |
| All-solid type | Electrode layer | — | Solid electrolyte |
| battery 8 | forming green sheet | | layer forming green |
| | 3 × 5 sheets | | sheet 1 × 50 sheets |

(5) Fabrication of Organic Electrolytic Solution Battery for Comparison

For comparison, batteries (organic electrolytic solution batteries 1 to 3) using an organic electrolytic solution that would constitute Comparative Examples 4 to 6 of Table 1 were fabricated, and similar evaluation was carried out. After a crystal powder of each electrode active substance shown in Table 1, carbon powder and polytetrafluoroethylene (PTFE) were weighed and mixed to attain a ratio of crystal powder:carbon powder:PTFE=20:70:10 (weight ratio), the sheet extended by using an extension rod was stamped out to a diameter of 12 mm, to obtain electrode layer forming green sheets 9 to 11. Subsequently, after electrode layer forming green sheets 9 to 11 were dried at 100° C. to remove the moisture component, a separator and metal lithium serving as a counterelectrode were sequentially superposed, followed by sealing with a 2032-type coil cell impregnated with an organic electrolytic solution, to fabricate organic electrolytic solution batteries 1 to 3.

### Test Example 1

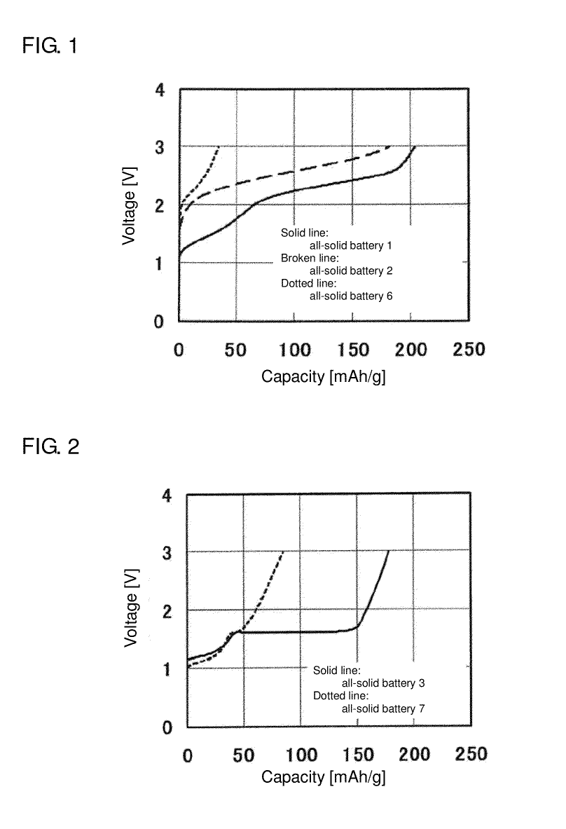

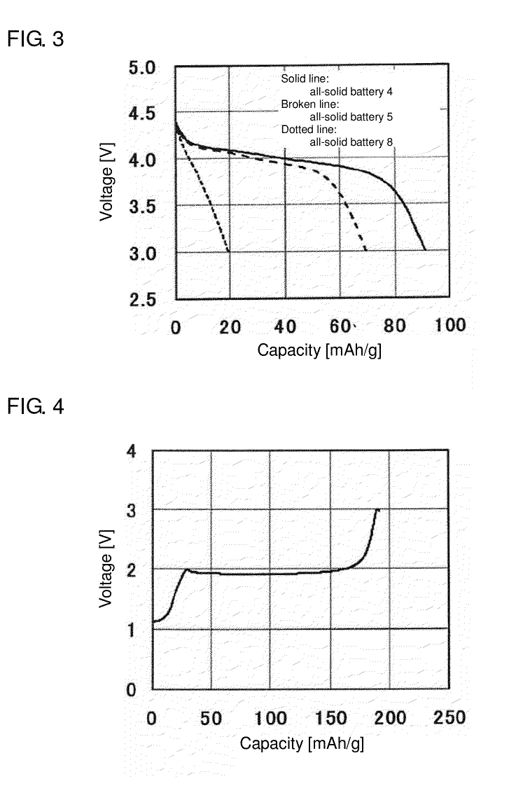

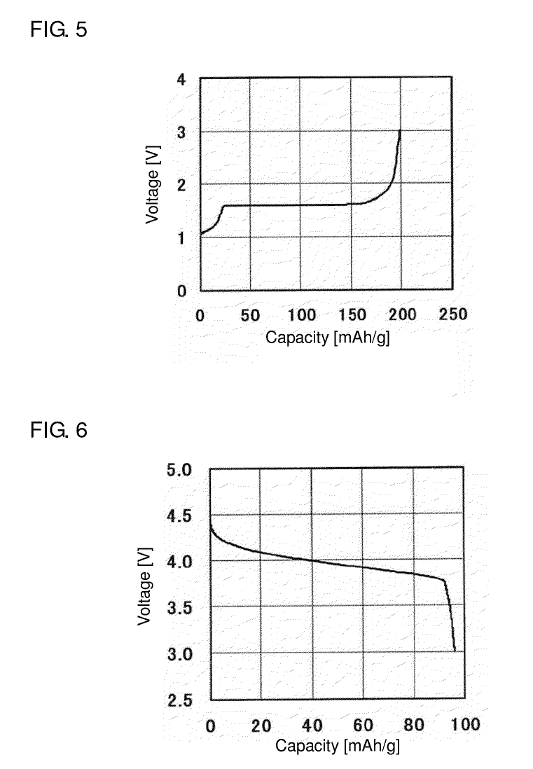

All-solid type batteries 1 to 3 and all-solid type batteries 6 to 7 were subjected to constant-current constant-voltage charging-discharging measurement within a range of 1 V to 3 V at 20 μA/cm². FIGS. 1 to 2 show the electric discharge curve thereof. Also, all-solid type batteries 4 to 5 and 8 were subjected to constant-current constant-voltage charging-discharging measurement within a range of 3 V to 4.5 V at 20 μA/cm². FIG. 3 shows the electric discharge curve thereof. In a similar manner, organic electrolytic solution batteries 1 to 3 were subjected to constant-current constant-voltage charging-discharging measurement within a range of 1.5 V to 3 V at 20 μA/cm². FIGS. 4 to 6 show the electric discharge curve thereof. Also, the electric discharge capacity of each of these batteries is shown in Table 4.

TABLE 4

| | Electric discharge capacity |
|---|---|
| | (mAh/g) |
| All-solid type battery 1 | 204 |
| All-solid type battery 2 | 182 |
| All-solid type battery 3 | 178 |
| All-solid type battery 4 | 91 |
| All-solid type battery 5 | 70 |
| All-solid type battery 6 | 34 |
| All-solid type battery 7 | 85 |
| All-solid type battery 8 | 19 |
| Organic electrolytic | 188 |
| solution battery 1 | |
| Organic electrolytic | 198 |
| solution battery 2 | |
| Organic electrolytic | 96 |
| solution battery 3 | |

As will be clear also from these results, it will be understood that all-solid type batteries 1 to 5 having an intermediate layer (Examples 1 to 5) have a larger electric discharge capacity than all-solid type batteries 6 to 8 that do not have an intermediate layer (Comparative Examples 1 to 3), and also no capacity deterioration of the electrode active substance is generated. Also, even when compared with organic electrolytic solution batteries 1 to 3 (Comparative Examples 4 to 6), the electric discharge capacity of all-solid type batteries 1 to 5 having an intermediate layer is no less inferior, and it will be understood that the electric discharge capacity of the electrode active substance is exhibited. Also, when titanium oxide is used as the electrode active substance, it will be understood that all-solid type battery 1 using Li₂TiO₃ as the intermediate layer can exhibit a higher electric discharge capacity than all-solid type battery 2 using Li₂MnO₃ as the intermediate layer. On the other hand, when manganese oxide is used as the electrode active substance, it will be understood that all-solid type battery 4 using Li₂MnO₃ as the intermediate layer can exhibit a higher electric discharge capacity than all-solid type battery 5 using Li₂TiO₃ as the intermediate layer.

What is claimed is:

1. A laminate for an all-solid type battery, the laminate comprising:
a solid electrolyte layer having first and second opposed surfaces;
a positive electrode layer adjacent the first surface of the solid electrolyte layer;
a negative electrode layer adjacent the second surface of the solid electrolyte layer, and
an intermediate layer disposed between at least one of (a) the positive electrode layer and the solid electrolyte layer and (b) the negative electrode layer and the solid electrolyte layer, wherein
the solid electrolyte layer contains a Li-containing oxide having a garnet crystal structure, and
the intermediate layer contains monoclinic Li₂MO₃, where M represents Ti or Mn.

2. The laminate for an all-solid type battery according to claim 1, wherein the laminate is a sintered body.

3. The laminate for an all-solid type battery according to claim 2, wherein the sintered body is a polycrystal body.

4. The laminate for an all-solid type battery according to claim 1, wherein the intermediate layer has a thickness of 1 μm to 50 μm.

5. The laminate for an all-solid type battery according to claim 1, wherein the Li-containing oxide is a Li—La—O oxide.

6. The laminate for an all-solid type battery according to claim 1, wherein a ratio by which the Li-containing oxide occupies the solid electrolyte layer is about 95 wt % to 100 wt %.

7. The laminate for an all-solid type battery according to claim 1, wherein the solid electrolyte layer does not contain a sulfur-containing Li compound, a nitrogen-containing Li compound or a phosphorus-containing Li compound.

8. The laminate for an all-solid type battery according to claim 1, wherein at least one of the positive electrode layer and the negative electrode layer contain an electrode active substance of at least one kind selected from a lithium titanium oxide and a titanium oxide, each capable of storing and releasing Li ions; and the intermediate layer contains monoclinic Li₂TiO₃.

9. The laminate for an all-solid type battery according to claim 8, wherein the electrode active substance is at least one kind selected from TiO₂, Li₄Ti₅O₁₂ and Li₂Ti₃O₇.

10. The laminate for an all-solid type battery according to claim 8, wherein a ratio by which the electrode active substance occupies the at least one of the positive electrode layer and the negative electrode layer is about 85 wt % to 99 wt %.

11. The laminate for an all-solid type battery according to claim 1, wherein the positive electrode layer and the negative electrode layer contain an electrode active substance of at least one kind selected from a lithium manganese oxide and a manganese oxide, each capable of storing and releasing Li ions; and the intermediate layer contains monoclinic Li₂MnO₃.

12. The laminate for an all-solid type battery according to claim 11, wherein the electrode active substance is at least one kind selected from LiMn₂O₄, MnO₂, LiNi_{0.5}Mn_{1.5}O₄ and Li₂MnO₃—LiRO₂ solid solution, where R represents Ni or Co.

13. The laminate for an all-solid type battery according to claim 11, wherein a ratio by which the electrode active substance occupies the at least one of the positive electrode layer and the negative electrode layer is about 85 wt % to 99 wt %.

14. An all-solid type battery comprising a laminate according to claim 1.
